(19) United States
(12) Patent Application Publication
(10) Pub. No.: US 2023/0343957 A1
(43) Pub. Date: Oct. 26, 2023

(54) ALL-SOLID-STATE BATTERY

(71) Applicant: SAMSUNG ELECTRO-MECHANICS CO., LTD., Suwon-si, Gyeonggi-do (KR)

(72) Inventors: Kyung-Lock Kim, Suwon-si, Gyeonggi-do (KR); Young-Jin Hwang, Suwon-si, Gyeonggi-do (KR); Myung-Jin Jung, Suwon-si, Gyeonggi-do (KR); Eun-Hyuk Kim, Suwon-si, Gyeonggi-do (KR); Won-Seh Lee, Suwon-si, Gyeonggi-do (KR); Tae-Hoon Kim, Suwon-si, Gyeonggi-do (KR); Jeong-Wook Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/026,651

(22) PCT Filed: Oct. 21, 2021
(86) PCT No.: PCT/KR2021/014840

§ 371 Date: Mar. 16, 2023

(30) Foreign Application Priority Data
Dec. 31, 2020 (KR) 10-2020-0189692

(51) Int. Cl. H01M 4/58; H01M 10/0562

(52) U.S. Cl. CPC H01M 4/5825; H01M 10/0562; H01M 10/052

(57) ABSTRACT

An all-solid-state battery includes an electrode assembly including a solid electrolyte layer and first and second internal electrodes stacked with the solid electrolyte layer interposed therebetween, a first external electrode connected to the first internal electrode, and a second external electrode connected to the second internal electrode. The first internal electrode and the second internal electrode include the same active material, and the active material includes a compound having an olivine-type crystal structure.

### TECHNICAL FIELD

The present disclosure relates to an all-solid-state battery.

### BACKGROUND ART

Recently, devices using electricity as an energy source are increasing. With the expansion of applications of devices using electricity as an energy source, such as smartphones, camcorders, laptop PCs, electric vehicles, or the like, interest in electric storage devices using electrochemical elements is increasing. Among various electrochemical elements, lithium secondary batteries that may be charged and discharged, have a high operating voltage, and have high energy density, have come into the spotlight.

A lithium secondary battery may be manufactured by applying a material capable of intercalating and de-intercalating lithium ions into a positive electrode and a negative electrode, and injecting a liquid electrolyte between the positive electrode and the negative electrode, and electricity may be generated or consumed by the reduction or oxidation reaction of the lithium secondary battery intercalating and de-intercalating the lithium ions in the negative electrode and the positive electrode. Such a lithium secondary battery should basically be stable in the operating voltage range of the battery, and should have performance capable of transferring ions at a sufficiently high rate.

When a liquid electrolyte, such as a nonaqueous electrolyte, is used in the lithium secondary battery, the discharge capacity and the energy density may be advantageously high. However, it may be difficult to implement high voltage lithium secondary batteries, and issues such as relatively high risk of electrolyte leakage, fires, and explosions may occur.

To address the above issues, a secondary battery using a solid electrolyte, rather than a liquid electrolyte, has been proposed as an alternative. The solid electrolyte may be classified as a polymer-based solid electrolyte or a ceramic-based solid electrolyte. The ceramic-based solid electrolyte is advantageous in exhibiting high stability. However, in the case of a solid-state battery using the ceramic-based solid electrolyte, efficiency of the battery may be reduced due to high interfacial resistance, and the lifespan of the battery itself may be shortened because the battery repeatedly contracts and expands during charging and discharging of the battery.

### DISCLOSURE OF INVENTION

### Technical Problem

An aspect of the present disclosure is to provide an all-solid-state battery having low interfacial resistance.

Another aspect of the present disclosure is to provide an all-solid-state battery for suppressing a decrease in capacity even when repeatedly charged and discharged.

### Solution to Problem

According to an aspect of the present disclosure, an all-solid-state battery includes an electrode assembly including a solid electrolyte layer and first and second internal electrodes stacked with the solid electrolyte layer interposed therebetween, a first external electrode connected to the first internal electrode, and a second external electrode connected to the second internal electrode. The first internal electrode and the second internal electrode include the same active material, and the active material includes a compound having an olivine-type crystal structure.

### Advantageous Effects of Invention

As described above, interfacial resistance of an all-solid-state battery may be decreased.

In addition, a decrease in capacity of an all-solid-state battery may be suppressed even when the all-solid-state battery is repeatedly charged and discharged.

### BRIEF DESCRIPTION OF DRAWINGS

The above and other aspects, features, and advantages of the present disclosure will be more clearly understood from the following detailed description, taken in conjunction with the accompanying drawings.

FIG. 1 is a schematic perspective view of an all-solid-state battery according to an exemplary embodiment of the present disclosure.

FIG. 2 is a perspective view of an electrode assembly of FIG. 1.

FIG. 3 is a cross-sectional view of FIG. 1.

FIG. 4 is a schematic perspective view of an electrode assembly of an all-solid-state battery according to another exemplary embodiment of the present disclosure.

FIG. 5 is a cross-sectional view of FIG. 4.

FIGS. 6 and 7 are graphs illustrating test results for an exemplary embodiment of the present disclosure.

### MODE FOR THE INVENTION

Hereinafter, embodiments of the present disclosure will be described in detail with reference to the accompanying drawings. The present disclosure may, however, be exemplified in many different forms and should not be construed as being limited to the specific embodiments set forth herein. Further, embodiments of the present disclosure may be provided for a more complete description of the present disclosure to those skilled in the art. Accordingly, the shapes and sizes of the elements in the drawings may be exaggerated for clarity of description, and the elements denoted by the same reference numerals in the drawings may be the same elements.

In order to clearly illustrate the present disclosure, portions not related to the description are omitted, and thicknesses are enlarged in order to clearly represent layers and regions, and similar portions having the same functions within the same scope are denoted by similar reference numerals throughout the specification.

In the present specification, expressions such as “have,” “may have,” “include,” “comprise,” “may include,” or “may comprise” may refer to the presence of corresponding features (for example, elements such as numbers, functions, actions, or components), and does not exclude the presence of additional features.

In the present specification, expressions such as “A and/or B,” “at least one of A and B,” or “one or more of A and B” may include all possible combinations of items listed together. For example, “A and/or B,” “at least one of A and B,” or “one or more of A and B” may refer to (1) including at least one A, (2) including at least one B, or (3) including all at least one A and at least one B.

In the drawings, an X direction may be defined as a first direction, an L direction, or a length direction, a Y direction may be defined as a second direction, a W direction, or a width direction, and a Z direction may be defined as a third direction, a T direction, or a thickness direction.

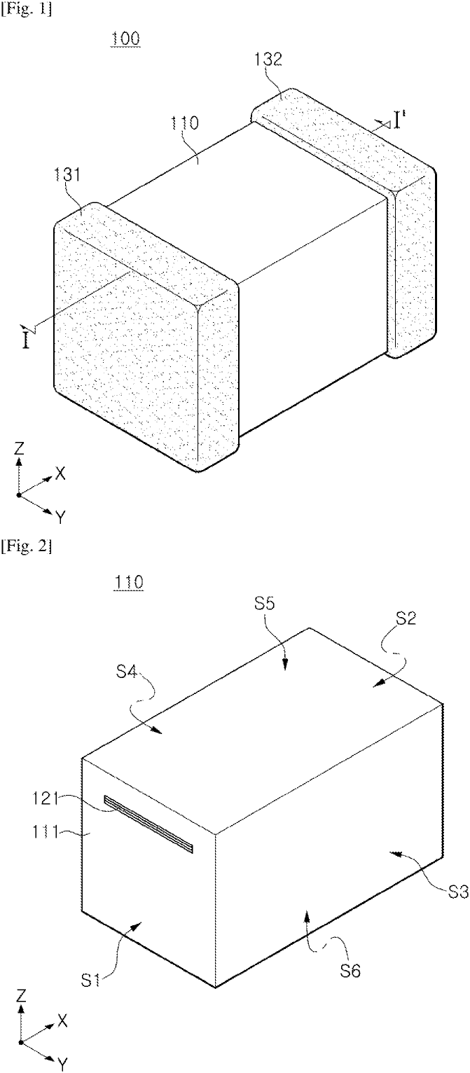

The present disclosure relates to an all-solid-state battery 100. FIGS. 1 to 3 are schematic views of an all-solid-state battery 100 according to an exemplary embodiment. Referring to FIGS. 1 to 6, the all-solid-state battery 100 according to the present disclosure may include an electrode assembly 110 including a solid electrolyte layer 111 and a first internal electrode 121 and a second internal electrode 122 stacked with the solid electrolyte layer 111 interposed therebetween, a first external electrode 131 connected to the first internal electrode 121, and a second external electrode 132 connected to the second internal electrode.

In this case, the first internal electrode 121 and the second internal electrode 122 may include the same active material. In addition, the active material may include a compound having an olivine-type crystal structure. In this specification, a compound having an “olivine-type crystal structure” may refer to a compound having an ABO₄ structure. Since the compound having an olivine-type crystal structure has a stable structure, it may have excellent structural stability. In the all-solid-state battery 100 according to the present disclosure, the active material may include a compound having an olivine-type crystal structure to implement reversible charge and discharge cycles.

In the all-solid-state battery 100 according to the present disclosure, the first internal electrode 121 and the second internal electrode 122 may include the same active material. The clause “the first internal electrode and the second internal electrode include the same active material” does not only mean that the same compound is included as a portion of the active material, but may mean that substantially the same compound is included as the active material. The phrase of “substantially” the same active material is included may mean that an average content of different components, among the components constituting the first internal electrode and the second internal electrode, is 10 mol% or less. The average content may refer to an average of the content of samples taken from 10 points of an internal electrode, closest to a center of the all-solid-state battery, arranged at regular intervals in a length direction. In the all-solid-state battery 100 according to the present disclosure, the first internal electrode 121 and the second internal electrode 122 have the same active material, and thus, a non-polar battery having no distinction between a positive electrode and a negative electrode may be implemented.

In one example of the present disclosure, the active material of the all-solid-state battery may include a compound represented by Formula 1 below.

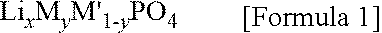

In Formula 1, 0.1≤x≤2, 0≤y≤1, and M and M′ may each be independently selected from the group consisting of iron (Fe), titanium (Ti), vanadium (V), manganese (Mn), chromium (Cr), cobalt (Co), nickel (Ni), copper (Cu), and zinc (Zn).

In another example of the present disclosure, the active material of the all-solid-state battery may include a nasicon-based compound. The nasicon-based compound is a compound based on a composition of Naₜ₊ₓZr₂Si₂P₃₋ₓO₁₂ (0≤x≤3), and Li ions may be positioned, rather than Na ions. In the nasicon-based compound, Al, Ti, Ge, V, or the like, may be substituted for Zr.

As an example, the active material of the all-solid-state battery may include lithium vanadium phosphate. The lithium vanadium phosphate may refer to a component of Liₓ V₂(PO₄)₃ (1 ≤ x ≤ 5). The lithium vanadium phosphate may have improved structural stability due to strong bonding force of a phosphate group, and may exhibit stable performance even in repeated charge and discharge cycles.

The active material of the all-solid-state battery 100 according to the present disclosure may selectively include a conductive material and a binder. The conductive material is not limited as long as it has conductivity without causing a chemical change in the all-solid-state battery 100 according to the present disclosure. For example, the conductive material may be or include graphite such as natural graphite or artificial graphite; a carbon-based material such as carbon black, acetylene black, ketjen black, channel black, furnace black, lamp black, or thermal black; a conductive fiber such as a carbon fiber and a metal fiber; carbon fluoride; metal powder such as aluminum or nickel powder; a conductive whisker such as a zinc oxide or potassium titanate whisker; a conductive metal oxide such as a titanium oxide; or a polyphenylene derivative.

The binder may be used to improve a bonding strength between the active material and the conductive agent. Examples of the binder may include polyvinylidene fluoride, polyvinyl alcohol, carboxymethylcellulose (CMC), starch, hydroxypropylcellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorine rubber, and various copolymers, but are not limited thereto.

In an exemplary embodiment, the first internal electrode 121 of the all-solid-state battery may include a first current collector 121a and an active material 121b, and the second internal electrode 122 may include a second current collector 122a and an active material 122b. The first current collector 121a and the second current collector 122a may have the same configuration. The first and second internal electrodes 121 and 122 may have, for example, a structure in which active materials 121b and 122b are disposed on both surfaces of the first and second current collectors 121a and 122a in a third direction Z.

The active material 121b/122b may form an active material layer on surfaces of the first current collector 121a and the second current collector 122a. An average thickness of the active material layer may be 5 µm or less. The average thickness of the active material layer may be an arithmetic average of values measured at 10 points arranged at regular intervals in a width direction with respect to the active material layer passing through the center of the all-solid-state battery and disposed in a centermost position on a cut surface, perpendicular to the X-axis, using, for example, a scanning electron microscope (SEM). A lower limit of the average thickness of the active material layer is not limited but may be, for example, 0.01 µm or more. Other methods and/or tools appreciated by one of ordinary skill in the art, even if not described in the present disclosure, may also be used. In one example, an average thickness of the solid electrolyte layer 111 may be 12 µm or less. An average thickness of the active material layer and the first current collector 121a may be 10 µm or less, and an average thickness of the active material layer and the second current collector 122a may be 10 µm or less. The average thickness of the solid electrolyte layer 111, the average thickness of the active material layer and the first current collector 121a, and the average thickness of the active material layer and the second current collector 122a, may be measured similarly based on the measurement of the average thickness of the active material layer.

As the first and second current collectors 121a and 122a, a net-shaped or mesh-shaped porous body may be used, a porous metal plate formed of stainless steel, nickel, copper, tin, aluminum, or the like, may be used, but exemplary embodiments are not limited thereto. In addition, the first and second current collectors 121 a and 122a may be coated with an anti-oxidation metal or an alloy film to prevent oxidation.

The first and second internal electrodes 121 and 122, applied to the all-solid-state battery 100 according to the present disclosure, may be prepared by directly coating a composition including an active material on a current collector including a metal, such as copper, and then drying the coated composition. Alternatively, an active material composition may be cast on a separate support, and then cured to prepare the first and second internal electrodes 121 and 122. In this case, a separate positive electrode current collector may not be included.

In an example of the present disclosure, the solid electrolyte layer 111 of the all-solid-state battery 100 may include a nasicon-based solid electrolyte. The nasicon-based solid electrolyte may include the same component as the above-described nasicon-based compound.

The nasicon-based solid electrolyte may include at least one of lithium~aluminum titanium phosphate (LATP) represented by Li₁₊ₓAlₓTi₂₋ₓ(PO₄)₃ (where 0<x<1), which is a compound of Li₁₊ₓAlₓM₂ ₋ₓ(PO₄)₃ (LAMP) (where 0<x<2 and M is Zr, Ti, or Ge) with Ti introduced thereinto, lithium aluminum germanium phosphate (LAGP) represented by Li₁₊ₓAlₓGe₂₋ₓ(PO₄)₃ (where 0<x<1) such as Li_{1.3}Al_{0.3}Ti_{1.7}(PO₄)₃ with an excessive amount of lithium introduced thereinto and/or lithium zirconium phosphate (LZP) represented by LiZr₂(PO₄)₃, and lithium-aluminum-titanium-silicon-phosphate (LATSP).

In an exemplary embodiment, the solid electrolyte layer 111 of the all-solid-state battery 100 may include magnesium (Mg). The magnesium (Mg) may serve to increase sintering density of the solid electrolyte, and may reduce an empty space in the solid electrolyte to improve ionic conductivity.

For example, the magnesium (Mg) may be doped into a solid electrolyte. As described above, the solid electrolyte includes phosphate. When a high voltage is applied, oxygen of the phosphate in the solid electrolyte may cause a phase transition to deteriorate performance of the battery itself. In addition, when the charge and discharge cycles are repeated, a short-circuit may occur due to metal deposition. The all-solid-state battery according to the present disclosure may include a solid electrolyte, doped with the magnesium (Mg), to effectively prevent a decrease in capacity caused by a short-circuit, or the like.

In an example of the present disclosure, the first internal electrode 121 and the second internal electrode 122 of the all-solid-state battery 100 may be stacked to be disposed in a third direction Z. Also, the first internal electrode 121 may be led out to one surface S1 of the electrode assembly 110 in the first direction X, and the second internal electrode 122 may be led out to the other surface S2 of the electrode assembly 110 in the first direction X. Specifically, the first internal electrode 121 may be led out to a first surface S1 of the electrode assembly 110, and the second internal electrode 122 may be led out to a second surface S2 of the electrode assembly 110.

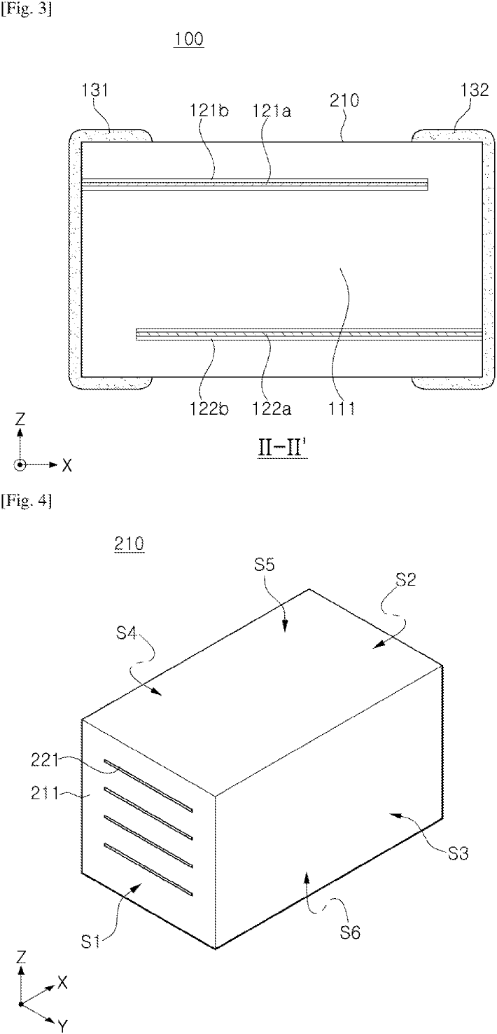

In another example of the present disclosure, the electrode assembly of the all-solid-state battery may include at least two or more first internal electrodes and two or more second internal electrodes. The two or more first internal electrodes and the two or more second internal electrodes may be alternately stacked with respective solid electrolyte layers interposed therebetween. Referring to FIGS. 4 and 5, a plurality of first internal electrodes 221 and a plurality of second internal electrodes 222 may be alternately stacked with respective solid electrolyte layers 211 interposed therebetween. The plurality of first internal electrodes 221 may be led out to a first surface S1 of the electrode assembly 210 to connected to a first external electrode 231, and the plurality of second internal electrodes 222 may be led out to a second surface S2 of the electrode assembly 210 to connected to a second external electrode 232. For example, the all-solid-state battery 200 according to the present example may have a multilayer structure. When the all-solid-state battery has a multilayer structure as in the present example, high capacity may be implemented. Other descriptions may refer to those described with reference to FIGS. 1-3 and thus will be omitted.

As an example, in the all-solid-state battery according to the present disclosure, in~ sulating members may be disposed on both surfaces of the electrode assembly in the second direction Y and on both surfaces of the electrode assembly in the third direction Z. Specifically, the insulating member may be disposed on a third surface S3, a fourth surface S4, a fifth surface S5, and a sixth surface S6 of the electrode assembly.

The insulating member may include a ceramic material, for example, alumina (Al₂O₃ ), aluminum nitride (AIN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), a mixture thereof, an oxide thereof, and/or a nitride thereof, or any other appropriate ceramic material, but is not limited thereto. In addition, the insulating member may selectively include the above-mentioned solid electrolyte, and may include one or more solid electrolytes, but exemplary embodiments are not limited thereto. The insulating member may basically serve to prevent permeation of external moisture and the like, and to prevent external physical and chemical impacts.

The all-solid-state battery according to the present disclosure may include a first external electrode and a second external electrode. The first external electrode may be disposed on the first surface of the electrode assembly and may be connected to the first internal electrode. The second external electrode may be disposed on the second surface of the electrode assembly and may be connected to the second internal electrode.

The first external electrode 131 and the second external electrode 132 may be formed by, for example, applying a terminal electrode paste including a conductive metal to respective opposite surfaces of the electrode assembly 110 in the first direction X. Alternatively, the first external electrode 131 and the second external electrode 132 may be formed by transferring a dry film, obtained by drying the conductive paste, to the electrode assembly 110 and then sintering the transferred film. However, exemplary embodiments are not limited to the above-described methods. The conductive metal may include or be at least one of, for example, copper (Cu), nickel (Ni), tin (Sn), palladium (Pd), platinum (Pt), gold (Au), silver (Ag), tungsten (W), titanium (Ti), lead (Pb), and alloys thereof, but exemplary embodiments are not limited thereto.

In an example of the present disclosure, a portion of the first external electrode 131 of the all-solid-state battery 100 according to the present disclosure may be disposed on one surface of the electrode assembly 110 in the first direction X, and the other portion of the external electrode 131 may extend upwardly of a surface, perpendicular to the first direction of the electrode assembly 110. In addition, a portion of the second external electrode 132 may be disposed on the other surface of the electrode assembly 110 in the first direction X, and the other portion of the second external electrode 132 may be disposed to extend upwardly of a surface, perpendicular to of the electrode assembly 110 in the first direction X. The extending portion may function as a so-called band portion, and may perform a moisture permeation preventing function of the all-solid-state battery 100 according to the present disclosure.

As an example, the all-solid-state battery 100 according to the present disclosure may further include plating layers (not illustrated), respectively disposed on the first external electrode 131 and the second external electrode 132. The plating layer may include at least one selected from the group consisting of copper (Cu), nickel (Ni), tin (Sn), palladium (Pd), platinum (Pt), gold (Au), silver (Ag), tungsten (W), titanium (Ti), lead (Pb), and alloys thereof, but exemplary embodiments are not limited thereto. The plating layer may be formed in a single layer or a plurality of layers, and may be formed by sputtering or electric deposition, but exemplary embodiments are not limited thereto.

### Experimental Example

A prototype chip used in an experiment was manufactured as follows.

A solid electrolyte was Mg-doped LATP(Mg_{0.05}Li_{1.2}Al_{0.1}Ti_{1.85}(PO₄)₃ doped with Mg by 5 mol%, and a binder and a solvent were mixed with powder having an average particle diameter of 1 µm to prepare slurry. The slurry was applied to a PET film to a thickness of about 20 µm, and then dried at a temperature of 60° C. to 80° C. to prepare an electrolyte sheet.

An active material/a current collector/an active material were sequentially printed on the prepared electrolyte sheet. The used active material was olivine-based Li₃V₂(PO₄)₃ (LVP), and a carbon conductive material and a binder were mixed to prepare slurry. As the current collector, a paste was prepared by proportionally mixing Ag/Pd alloy powder, having an average particle diameter of about 0.3 µm, with the binder. The active material and the current collector were printed on an electrolyte sheet, and then were dried at a temperature of 60° C. to 80° C.

First stacking of the electrolyte sheet, on which the active material/the current collector/the active material were sequentially printed, was performed at a pressure of 100 kgf/cm². When each layer is stacked, a film having an adhesion force was formed, and then PET was peeled off to be separated from the film. A completed stacked body was vacuum-packed with plastic, and then compression of ISO was performed at a temperature of 80° C. and a pressure of 1000 kgf under a retention time of 30 minutes.

The compressed stacked body was cut to a size of 10 mm x 10 mm using a blade, and then calcined at a temperature of 450° C. to 500° C. in an air atmosphere for 42 hours to remove an organic binder.

After the calcination, sintering was performed at a temperature of 700° C. to 900° C. in a weak reduction-nitrogen atmosphere under a retention time of 3 hours. A silver (Ag) paste was applied to an external electrode portion of the fully sintered electrode assembly, and then cured at a temperature of 150° C.

A result of measuring the cut surface of a central portion of the manufactured prototype chip was that a thickness of an internal electrolyte was about 12 µm, a thickness of the current collector was about 3.5 µm, and a thickness of the active material was about 3.5 µm, a thickness of the internal electrode including the active material/the current collector/the active material was about 10 µm, and overall resistance was limited to a level of about 1.0 to 2.5 kΩ.

By testing manufactured prototype chips, a charge/discharge test was performed on normal chips except for chips having initial defects. To determine whether chips had initial defects, a parallel tester measured overall resistance and normal and defective chips were determined based on 800 Ω.

The charge/discharge test was performed at a temperature of 25° C. inside a constant temperature chamber. Charging and discharging were measured using an analyzer (Solartron 1470E) under the following conditions: a cutoff range of 0 to 1.6 V, a C-rate of 0.1, and current of 0.05 uA. The charging was maintained for 5 hours after a voltage increased from 0 to 1.6 V, and then a pause time of 3 hours was given. The discharging was performed to 0 V at current of 0.05 uA, and then a pause time of 3 hours was given.

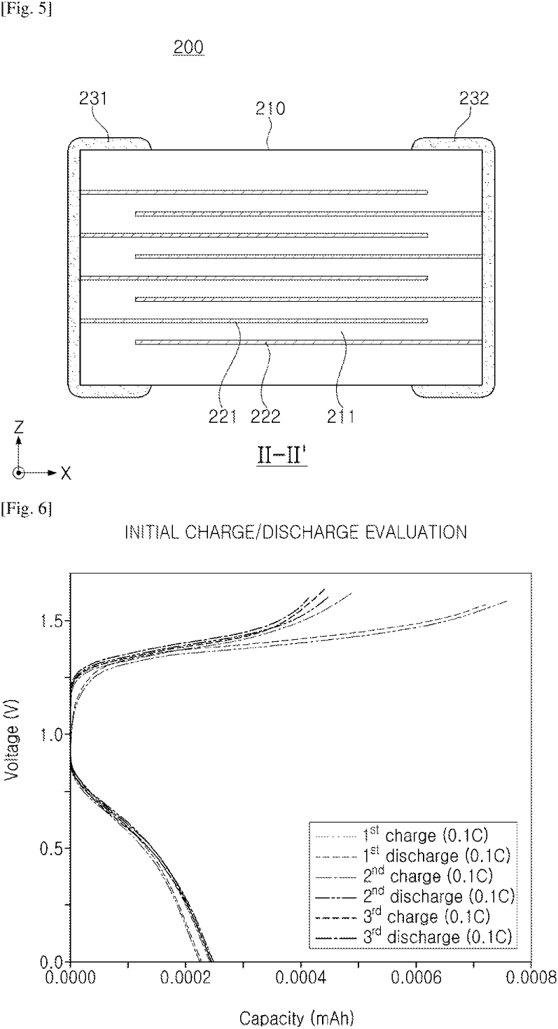

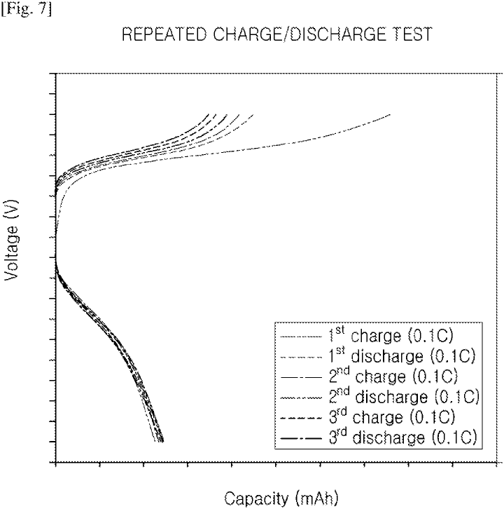

FIGS. 6 and 7 illustrate test results of the charge/discharge test. Referring to FIGS. 6 and 7, typical charge/discharge curves were shown during initial charging and discharging, and capacity was measured to be about 0.23 uAh. As can be seen from the drawings, a repeating cycle was entailed 7 times and capacity had a high-reproducibility level.

While exemplary embodiments have been shown and described above, it will be apparent to those skilled in the art that modifications and variations could be made without departing from the scope of the present disclosure as defined by the appended claims.

1] An all-solid-state battery comprising:
an electrode assembly including a solid electrolyte layer and first and second internal electrodes stacked with the solid electrolyte layer interposed therebetween;
a first external electrode connected to the first internal electrode; and
a second external electrode connected to the second internal electrode, wherein the first internal electrode and the second internal electrode include the same active material, and
the active material includes a compound having an olivine-type crystal structure.

2] The all-solid-state battery of claim 1, wherein the active material includes a compound represented by Formula 1 below, 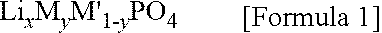
in Formula 1, 0.1≤x≤2, 0≤y≤1, and M and M′ are each independently selected from the group consisting of iron (Fe), titanium (Ti), vanadium (V), manganese (Mn), chromium (Cr), cobalt (Co), nickel (Ni), copper (Cu), and zinc (Zn).

3] The all-solid-state battery of claim 1, wherein the active material includes a nasicon-based compound.

4] The all-solid-state battery of claim 1, wherein the active material includes lithium vanadium phosphate.

5] The all-solid-state battery of claim 1, wherein the solid electrolyte layer includes a nasicon-based solid electrolyte.

6] The all-solid-state battery of claim 1, wherein the solid electrolyte layer includes at least one of lithium-aluminum-germanium-phosphate (LAGP), lithium-aluminum-titanium-phosphate (LATP), and lithium-aluminum-titanium-silicon-phosphate (LATSP).

7] The all-solid-state battery of claim 1, wherein the solid electrolyte layer includes at least magnesium (Mg).

8] The all-solid-state battery of claim 7, wherein the magnesium (Mg) is doped into a solid electrolyte included in the solid electrolyte layer.

9] The all-solid-state battery of claim 1, wherein the first internal electrode further includes a first current collector, and the second internal electrode further includes a second current collector.

10] The all-solid-state battery of claim 1, wherein the electrode assembly includes two or more first internal electrodes and two or more second internal electrodes.

11] The all-solid-state battery of claim 10, wherein the two or more first internal electrodes and the two or more second internal electrodes are alternately stacked with respective solid electrolyte layers interposed therebetween.

12] The all-solid-state battery of claim 1, wherein an average thickness of an active material layer including the active material is 5 µm or less.

13] The all-solid-state battery of claim 1, wherein an average thickness of the solid electrolyte layer is 12 µm or less.

14] The all-solid-state battery of claim 1, wherein an average thickness of the first current collector and an active material layer including the active material is 10 µm or less.

15] The all-solid-state battery of claim 1, wherein an average thickness of the second current collector and an active material layer including the active material is 10 µm or less.
